(19) United States
(12) Patent Application Publication
(10) Pub. No.: US 2011/0135787 A1
(43) Pub. Date: Jun. 9, 2011

(54) DEODORIZING COMPOSITION USING PEROXIDASE UNDER NEUTRALITY

(75) Inventors: Takahito Takase, Saitama-shi (JP); Atsushi Narise, Saitama-shi (JP); Sanae Kikuchi, Saitama-shi (JP); Kenji Osawa, Tokyo (JP)

(73) Assignee: LOTTE CO. LTD.

(21) Appl. No.: 13/058,420

(22) PCT Filed: Aug. 4, 2009
(86) PCT No.: PCT/JP2009/064090

§ 371 Date: Feb. 10, 2011

(30) Foreign Application Priority Data
Aug. 11, 2008 (JP) 2008-207067

(51) Int. Cl. A23L 1/30; A23G 4/06; A23G 3/36

(52) U.S. Cl. 426/3; 426/61

(57) ABSTRACT

Provided are a deodorizing composition which contains a highly safe natural plant extract that can be used in foods without anxiety as an active ingredient, and has a high deodorization effect even under a neutral condition, and a food and drink article containing the deodorizing composition. The deodorizing composition is characterized by containing a plant belonging to the genus Rubus in the family Rosaceae and peroxidase.

### TECHNICAL FIELD

The present invention relates to a deodorizing composition containing peroxidase and an extract from plants belonging to the genus Rubus in the family Rosaceae under a neutral condition, and food and drink articles containing the same.

### BACKGROUND ART

Conventionally, masking with an aromatic substance, chemical deodorization with an antioxidant, a neutralizing agent, or a fixing agent, and a method of eliminating an offensive odor by adsorption with active charcoal or the like have been used as methods of deodorizing and removing offensive odors, but those methods are often constrained remarkably depending on the intended uses of the methods. Particularly in the food field, deodorizers including cyclodextrin, chlorophylls, and several plant extracts as active ingredients have been patented, but each of the deodorizers has had a problem in that the deodorizer excessively affects a flavor and a sense of use of a subject to which the deodorizer is added due to aspects such as its inherent color, odor, bitter taste, or astringent taste when added to foods or the like, and that its effect may not be sufficient. As the deodorizer which has solved such problems and has an excellent deodorization effect, extracts of natural matters such as galenicals and herbs which have no side effect, have a high safety, and have been used since ancient times have attracted attention. Of those, an extract from a plant belonging to the genus Rubus in the family Rosaceae, which exhibits a strong deodorization effect, has been found and its applications have been developed.

It has been known that the plant belonging to the genus Rubus in the family Rosaceae exhibits a strong deodorization effect on methyl mercaptan which is a thiol compound, trimethylamine which is a nitrogen compound, and further allylmethyl monosulfide which is a monosulfide compound. In addition, a deodorizing composition including Tien-cha derived from the plant belonging to the same genus as an active ingredient has also been known as a deodorizing material. The extract from the plant belonging to the genus Rubus in the family Rosaceae exhibits the high deodorization effect and high safety, and thus is applied to various food and drink articles including confectionery.

However, it has been desired that the deodorization effect is further strengthened and sustained in the deodorizing composition including the extract from the plant belonging to the genus Rubus in the family Rosaceae as the active ingredient. For example, in order to further enhance the deodorization effect of the extract from the plant belonging to the genus Rubus in the family Rosaceae in food and drink articles under a neutral condition in an oral cavity environment, it became necessary to contain the extract from the plant belonging to the genus Rubus in the family Rosaceae in a much larger amount than a conventionally applied amount. As a result, the properties of the composition were reduced, e.g., the flavor of the composition was impaired, or the deodorizing composition became expensive. Consequently, inconvenience occurred in some cases in terms of practical use.

Thus, the inventors of the present invention extensively studied on combinations with various ingredients so that the deodorization effect can be maintained or enhanced without increasing the amount of the extract from the plant belonging to the genus Rubus in the family Rosaceae to be contained in the deodorizing composition. As a result, the inventors of the present invention have found that the deodorization effect is remarkably enhanced by combining the extract from the plant belonging to the genus Rubus in the family Rosaceae (Tien-cha, blackberry, and raspberry) with peroxidase which is an enzyme under the neutral condition (pH 6.0 to 8.0).

Conventionally, many studies on the deodorization effect by the combination of the plant extract with the enzyme have been performed.

Examples of articles concerning the deodorization effect by the combination of the plant extract with polyphenol oxidase include Food Science and Technology Research, 5(2), 176-180, 1999, Japan Association for the Integrated Study of Dietary Habits, 10(3), 15-19, 1999, The Takasago Times, No. 133, p 6-14 (Dec. 5, 1999), and Biosci. Biotech. Biochem., 61(12), 2080-2084, 1997. Those articles disclose the deodorization effects and deodorizing mechanism involved when using vegetables, fruits, or mushrooms in combination with an enzyme (polyphenol oxidase). However, the deodorization effect by the combination of extract from the plant belonging to the genus Rubus in the family Rosaceae with peroxidase is not described in any articles.

Further, as the article concerning the deodorization effect by the combination of the plant extract with polyphenol oxidase, Esthetic Dentistry Vol. 17, No. 1, p 90-94 (September, 2004) is available in addition to the above articles. Esthetic Dentistry Vol. 17, No. 1, p 90-94 (September, 2004) is an article concerning the enhancement of the deodorization effect by the combination of rosemary extract with laccase, and it has been described that a deodorizing power in the above combination was augmented in the range at pH 4.5 to 6.0. However, no deodorization effect by the combination of the extract from the plant belonging to the genus Rubus in the family Rosaceae with peroxidase is described.

Examples of documents concerning the deodorization effects by the combination of mushroom extracts and ku-ding-cha with polyphenol oxidase include J. Agric. Food Chem., 2001, 49(11), 5509-5514 and J. Agric. Food Chem., 2004, 52(17), 5513-5518. J. Agric. Food Chem., 2001, 49(11), 5509-5514 is an article concerning the methylmercaptan-trapping capacity of mushroom extracts containing polyphenol and J. Agric. Food Chem., 2004, 52(17), 5513-5518 is an article concerning the deodorization effects of ku-ding-cha extracts, green tea extracts, black tea extracts, and oolong tea extracts in combination with fruit-derived polyphenol oxidase. However neither of the documents describes the deodorization effect by the combination of the extract from the plant belonging to the genus Rubus in the family Rosaceae with peroxidase.

As the documents concerning the deodorization effect of the extract from the plant belonging to the genus Rubus in the family Rosaceae, Japanese Patent Publication No. 05-36061, Japanese Patent Application Laid-Open No. 2003-335647, and Japanese Patent No. 3,633,634 are available. Japanese Patent Publication No. 05-36061 and Japanese Patent Application Laid-Open No. 2003-335647 disclose the deodorization by the extracts of Tien-cha, raspberry, and blackberry, which are the plants belonging to the genus Rubus in the family Rosaceae, for trimethylamine, methyl mercaptan, and allylmethyl monosulfide. Japanese Patent No. 3,633,634 discloses a deodorizer including a Tien-cha extract for methyl mercaptan and trimethylamine. However, in any of the above patents, it is not described that the deodorization effect is remarkably enhanced by combining the extract from the plant belonging to the genus Rubus in the family Rosaceae with peroxidase under the neutral condition.

Examples of documents relating to deodorization effects of enzymes such as polyphenol oxidase and laccase include Japanese Patent Application Laid-Open No. 2004-148046, Japanese Patent Application Laid-Open No. 09-038183 (Japanese Patent No. 3,562,668), Japanese Patent Application Laid-Open No. 2003-175095 (Japanese Patent No. 3,766,375), Japanese Patent Application Laid-Open No. 10-212221 (Japanese Patent No. 3,625,976), Japanese Patent Application Laid-Open No. 2001-095910 (Japanese Patent No. 3,741,914), and Japanese Patent Application Laid-Open No. 2003-009784. Japanese Patent Application Laid-Open No. 2004-148046 discloses a deodorizing composition using water soluble lignin in combination with polyphenol oxidase, Japanese Patent Application Laid-Open No. 09-038183 (Japanese Patent No. 3,562,668) discloses a deodorizing composition using a phenolic compound in combination with polyphenol oxidase, Japanese Patent Application Laid-Open No. 2003-175095 (Japanese Patent No. 3,766,375) and Japanese Patent Application Laid-Open No. 10-212221 (Japanese Patent No. 3,625,976) both disclose a deodorizing composition using each extract of tea, rosemary, sunflower seeds, raw coffee beans, and the like in combination with polyphenol oxidase, Japanese Patent Application Laid-Open No. 2001-095910 (Japanese Patent No. 3,741,914) discloses a deodorizing composition using glycoside of a phenolic compound in combination with laccase, and Japanese Patent Application Laid-Open No. 2003-009784 discloses a food and drink article having a deodorization effect characterized by including a pulp obtained using a plant disintegrating liquid having an oxidoreductase activity. However, in any of the above documents, it has not been described that the deodorization effect is remarkably enhanced by combining the extract from the plant belonging to the genus Rubus in the family Rosaceae with peroxidase under the neutral condition.

As the document in which laccase was applied to various confectionery such as chewing gums, candies, tablets, or gummies, Japanese Patent Application Laid-Open No. 2004-148046 is available. Japanese Patent Application Laid-Open No. 2004-148046 discloses a chewing gum characterized by containing a capsule in which laccase is contained and a rosemary extract. However, it is not described that the deodorization effect is remarkably enhanced by combining the extract from the plant belonging to the genus Rubus in the family Rosaceae with peroxidase under the neutral condition.

As described above, there are documents concerning the enhancement of the deodorization effect by the combination of a plant extract with an enzyme, but there is still no document which has disclosed or suggested that the deodorization effect by the extract from the plant belonging to the genus Rubus in the family Rosaceae is remarkably enhanced even under the neutral condition by combining with peroxidase as an enzyme.

### DISCLOSURE OF THE INVENTION

It is an object of the present invention to solve a problem in that an increase in a content of an extract from a plant belonging to the genus Rubus in the family Rosaceae in a composition leads to the reduction of properties or the higher price of the composition, and to remarkably enhance the deodorization effect under the neutral condition without increasing the content of the extract from the plant belonging to the genus Rubus in the family Rosaceae. The present invention can further provide food and drink articles, such as chewing gums, candies, tablets, and gummy jellies, having a deodorizing function under the neutral condition. The present invention can also provide neutral oral care products having a deodorizing function, neutral skin care products, hair care products, and deodorizers having a deodorizing function.

In order to solve the problem in that increasing a content of an extract from a plant belonging to the genus Rubus in the family Rosaceae in a composition leads to the reduction of properties or the higher price of the composition, and to remarkably enhance the deodorization effect under the neutral condition without increasing the content of the extract from the plant belonging to the genus Rubus in the family Rosaceae, materials whose deodorization effect under the neutral condition was expected were searched. As a result, it has been confirmed that a deodorizing activity is remarkably enhanced by combining the extract from the plant belonging to the genus Rubus in the family Rosaceae (Tien-cha, blackberry, and raspberry) with peroxidase under the neutral condition (pH 6.0 to pH 8.0).

The present invention provides a deodorizing composition including a plant belonging to the genus Rubus in the family Rosaceae and peroxidase.

Further, the present invention provides a deodorizing composition described above, in which the plant belonging to the genus Rubus in the family Rosaceae is one or two or more extracts selected from the group consisting of a Tien-cha extract, a blackberry extract, and a raspberry extract.

Still further, the present invention provides a deodorizing composition described above, in which a pH in saliva after ingesting the deodorizing composition is in a range of 6.0 or higher and 8.0 or lower.

Still further, the present invention provides a chewing gum, a candy, a tablet, or a gummy jelly, including the deodorizing composition described above.

Still further, the present invention provides a deodorizing composition described above, in which a content of the plant belonging to the genus Rubus in the family Rosaceae in the deodorizing composition is 0.01% by weight or more and 5.0% by weight or less and a content of the peroxidase in the deodorizing composition is 0.01 ppm or more and 10 ppm or less.

Still further, the present invention provides a deodorizing composition described above, in which a content of the plant belonging to the genus Rubus in the family Rosaceae in the deodorizing composition is 0.01% by weight or more and 5.0% by weight or less and a titer of the peroxidase added in the deodorizing composition is 0.18 U or more and 180 U or less in terms of 100 g of the deodorizing composition.

### BRIEF DESCRIPTION OF THE DRAWING

FIG. 1 is a graph illustrating a relationship between a deodorization rate for methyl mercaptan and an enzyme relative activity of peroxidase at each pH.

### BEST MODE FOR CARRYING OUT THE INVENTION

The present invention is described in detail below.

The deodorizing composition of the present invention includes a plant belonging to the genus Rubus in the family Rosaceae as a main raw material.

The plant belonging to the genus Rubus in the family Rosaceae includes raspberry (Rubus idaeus), blackberry (Rubus fruticosus), kaji-ichigo (Rubus trifidus), thimbleberry (Rubus occidentalis), and Tien-cha (Rubus suavissimus). There are used fruit skins, leaves, fleshes of fruits, fruits, woody parts, barks, and roots of the plants belonging to the genus Rubus in the family Rosaceae, and their dried leaves are preferably used. A method of obtaining the extract of the above plant which is the active ingredient of the present invention is not particularly limited, and the extract is prepared by pulverizing any of the plants by an appropriate pulverization means and extracting by a method such as a solvent extraction including a two-stage extraction. As an extraction solvent, water, lower alcohols such as methanol, ethanol, n-propanol, and n-butanol, and organic solvents such as ether, chloroform, ethyl acetate, acetone, glycerine, and propylene glycol are used alone or in mixture of two or more kinds, and water or a hydrophilic organic solvent is preferably used. Further, considering that the extract of the present invention is often used for human beings or as food and drink articles, the combination of water and ethanol can be preferably used in terms of safety as the extraction solvent.

As an extraction condition, the extraction can be performed at any of high temperature, room temperature or low temperature, but it is preferred that the extraction be performed at 50 to 90° C. for about 1 to 5 hours. The resulting extract may be filtrated, and concentrated or lyophilized under reduced pressure after distilling off the extraction solvent. Those obtained by fractionating and purifying the extracts using, for example, an organic solvent and column chromatography can be used.

Further, in terms of good aroma and taste, and high stability, the deodorizing composition of the present invention can be incorporated into: deodorizing compositions such as a mouthwash, toothpaste, and deodorant spray; or foods and drinks including confectionery such as a chewing gum, candy, tablet candy, gummy jelly, chocolate, biscuit, and snack, frozen desserts such as ice cream, sherbet, and frozen food products, drinks, bread, pancakes, dairy products, meat products such as ham and sausages, fish products such as Kamaboko (fish meat paste) and Chikuwa (boiled fish paste), prepared foods, puddings, soup, and jams, with the result that the deodorizing composition of the present invention can be used on a daily basis. In addition to consumable products, by incorporating the deodorizing composition of the present invention into soap, shampoo, conditioner, cream, lotion, pet deodorants, room deodorants, air conditioning filters, and bathroom deodorants, neutral products having excellent deodorization activity can be produced.

The amount to be blended can vary depending on various production conditions. It is suited that the plant belonging to the genus Rubus in the family Rosaceae be blended in an amount of 0.01% by weight or more and 5.0% by weight or less, preferably 0.05% by weight or more and 2.0% by weight or less in terms of the deodorizing composition. The amount of peroxidase to be added varies depending on a titer of a peroxidase preparation. It is suited that peroxidase be blended in an amount of 0.01 ppm or more and 10 ppm or less and preferably 0.01 ppm or more and 2 ppm or less in terms of the deodorizing composition.

Showing the amount of added peroxidase in titer, it is suited that the titer of peroxidase to be blended be 0.18 U or more and 180 U or less and preferably 0.18 U or more and 36 U or less in terms of 100 g of the deodorizing composition.

### EXAMPLES

The present invention is described in more detail below with reference to examples, but the present invention is not limited thereto.

### Example 1

Preparation Method of Samples

### Example 1-1

Enzyme Used

Peroxidase (Toyobo Co., Ltd., titer: 180 U/mg or more) was dissolved in a phosphate buffer and used.

### Example 1-2

Measuring Method of Enzyme Activity

A mixed solution of 2.0 mL of 5% (w/v) pyrogallol solution, 1.0 mL of an aqueous solution of 0.147 M H₂O₂, 2.0 mL of 0.1 M phosphate buffer (pH 6.0), and 14.0 mL of distilled water is prepared in a test tube, and pre-warmed at 20° C. for about 5 minutes. Then, 1.0 mL of an enzyme solution (an enzyme is dissolved in 0.1 M phosphate buffer, pH 6.0) is added to the reaction solution to start a reaction. After reacting at 20° C. for 20 seconds, 1.0 mL of 2N H₂SO₄ solution is added to stop the reaction. Produced purpurogallin is extracted with 15 mL of ether from the mixed solution after stopping the reaction. The manipulation is repeated five times, extracted solutions are combined, and ether is further added to make a total volume 100 mL. An absorbance at 420 nm is measured for the solution. A blank sample is prepared by adding 1.0 mL of 2N H₂SO₄ solution to the above reaction solution and mixing after the reaction solution is left to stand at 20° C. for 20 seconds, and then adding 1.0 mL of the enzyme solution. The solution is subjected to extraction with ether and an absorbance is measured in the same manner as in the case above.

U/ml=(sample absorbance−blank absorbance)×dilution factor/0.117

U/mg=U/ml×1/C
0.117: 1 mg % absorbance in 420 nm of a Purpurogallin ether solution
C: Enzyme concentration when dissolved (mg/ml)

### Example 1-3

Plants Used

As the plants belonging to the genus Rubus in the family Rosaceae, Rubus suavissimus and Rubus fruticosus were used, and as control plants, rosemary and green tea were used.

### Example 1-4

Preparation Method of Tien-cha Extract (Use of Two-Stage Extraction Article (Japanese Patent Application No. 2006-223707))

300 mL of 100% ethanol were added as a pretreating agent to 30 g of Tien-cha leaf dry powder, and using a reflux condenser, the extraction was performed with refluxing at 60° C. for 1 hour. Subsequently 300 mL of water were added to an extraction residue obtained by filtration, and using the reflux condenser, the extraction was performed with refluxing at 90° C. for 1 hour. The resulting extraction solution was filtrated, the solvent was removed, and then 6.4 g of an extract (yield: 21%) were obtained by lyophilization.

### Example 1-5

Preparation Method of Blackberry, Rosemary, and Green Tea Extracts

Water (300 mL) was added to 30 g of blackberry dry leaf powder, and using the reflux condenser, the extraction was performed with refluxing at 90° C. for 1 hour. The resulting extraction solution was filtrated, the solvent was removed, and then 5.2 g of an extract (yield: 17.4%) were obtained by lyophilization. Likewise, 5.2 g (17.2%) of a rosemary extract and 9.8 g (yield: 32.6%) of a green tea extract were obtained.

### Example 1-6

Production of Tablets Containing Tien-cha Extract and Peroxidase

The raw materials described in a formulation example in the following Table 1 were mixed and tablets were obtained by a common method.

TABLE 1

| | Example tablet |
|---|---|
| | (% by weight) |
| Glucose | 92 |
| Sugar ester | 4 |
| Flavor | 1 |
| Tien-cha extract | 0.01 to 2.0 |
| Peroxidase (180 U/mg) | 0.000001 to 0.0002 |
| Water | Balance |

### Example 1-7

Production of Chewing Gum Containing Tien-cha Extract and Peroxidase

The raw materials including the prepared Tien-cha extract and peroxidase described in the formulation example in the following Table 2 were mixed and an example chewing gum was obtained by a common method.

A control example chewing gum containing no peroxidase and containing the prepared Tien-cha extract as a deodorizing material was obtained by a common method.

TABLE 2

| | Control example chewing | Example chewing |
|---|---|---|
| | gum (% by weight) | gum (% by weight) |
| Gum base | 20 | 20 |
| Xylitol | 45 | 45 |
| Maltitol | 33 | 33 |
| Flavor | 2 | 2 |
| Total | 100 | 100 |
| | The following materials were | |
| | added to the above formulation. | |
| Tien-cha extract | 0.25 | 0.25 |
| Peroxidase (180 U/mg) | — | 0.00002 |

### Example 2

Deodorization Test Method

### Example 2-1

Deodorization Test with Enzyme

A sample was precisely weighed in a vial, 1 mL of phosphate buffer (pH 5.0 to 9.0) was added and dissolved or dispersed well, 100 μL of the enzyme solution was then added, further, 500 μL of a solution of 25 ppm sodium methyl mercaptan were added. Then, the vial was sealed with a rubber plug coated with Teflon (registered trade name), and the mixture was reacted at 37° C. for 5 minutes. After the reaction, 150 μL of gas in a head space in the vial was injected in a gas chromatograph equipped with an FPD detector, and the amount of methyl mercaptan was calculated from a height of an obtained peak.

### Example 2-2

Evaluation of Deodorizing Activity

The amount of methyl mercaptan when the sample was added (M_{S}) and the amount of methyl mercaptan when no sample was added (M_{B}) were obtained, and a deodorization rate for methyl mercaptan was calculated by the following formula.

Deodorization rate for methyl mercaptan (%)=(M_{B}−M_{S})/M_{B}×100

### Example 2-3

Deodorization Test Method I of Produced Tablet

In a vial, 2 g of the produced tablet were precisely weighed as a sample, 8 mL of 0.2 M phosphate buffer (pH 7.5) were added, and the tablet was dissolved well therein to make a test solution. 500 μL of a solution of 25 ppm sodium methyl mercaptan were added to 1 mL of the test solution, the vial was sealed with a rubber plug coated with Teflon (registered trade name), and the mixture was reacted at 37° C. for 5 minutes. After the reaction, 150 μL of gas in the head space in the vial were injected in a gas chromatograph equipped with an FPD detector, and the amount of methyl mercaptan was calculated from the height of an obtained peak.

### Example 2-4

Sensory Evaluation Method

In a sensory evaluation method, oral odors were collected from five subjects 10 minutes before the test, and subsequently, the subjects ingested six steam-baked meat pies in two minutes, oral breath immediately after ingesting the steam-baked meat pies was collected in an odor bag. Then, the subjects ingested the produced example chewing gum and control example chewing gum (mastication for 5 minutes) or gargled (washed out twice with 20 mL of water), oral breath immediately after the ingestion or the gargle was collected in an odor bag, and the degrees of the oral odors were evaluated by three panelists for the sensory evaluation. The panelists for the sensory evaluation evaluated the odor in the odor bag collected from the five subjects according to the following Table 3, and values evaluated by the three panelists for the sensory evaluation were averaged and digitalized.

TABLE 3

| Score | Determination criteria |
|---|---|
| 5 | Overpowering odor |
| 4 | Strong odor |
| 3 | Odor detected easily |
| 2 | Weak odor whose source can be understood |
| 1 | Odor scarcely detected |
| 0 | No odor |

### Example 3

Deodorization Rates of Extract from Plant Belonging to the Genus Rubus in the Family Rosaceae, Green Tea Extract, and Rosemary Extract

A comparative test of the deodorization rates of the extract from the plant belonging to the genus Rubus in the family Rosaceae, the green tea extract, and the rosemary extract for methyl mercaptan under the neutral condition was performed according to the test method in Example 2-1. Note that, in the example, the amount of the extract from the plant belonging to the genus Rubus in the family Rosaceae contained in a reaction system at pH 6.0 or 7.0 was 1 mg each, the amount of the enzyme was 0 ng (described as “peroxidase (−)” in Table 4) or 100 ng (described as “peroxidase (+)” in Table 4), and the reaction was performed at 37° C. for 5 minutes.

As a result, as is evident from the following Table 4, it was observed that the extract from the plant belonging to the genus Rubus in the family Rosaceae increased the deodorization rate for methyl mercaptan in the range at pH 7 by adding peroxidase. Further, it was observed that the extract from the plant belonging to the genus Rubus in the family Rosaceae remarkably increased the deodorization rate for methyl mercaptan in the range at pH 6 to 7 by adding peroxidase. In addition, it was confirmed that the extract from the plant belonging to the genus Rubus in the family Rosaceae was better in deodorizing activity in the range at pH 6 to 7 than the rosemary extract and the green tea extract used as the control examples.

TABLE 4

| | | Deodorization rate for | |
|---|---|---|---|
| | | methyl mercaptan (%) | |
| pH | Extract | Peroxidase (+) | Peroxidase (−) |
| pH 6.0 | Tien-cha | 14 | 8 |
| | Blackberry | 12 | 2 |
| | Rosemary (Control example) | 10 | 6 |
| | Green tea (Control example) | 8 | 7 |
| pH 7.0 | Tien-cha | 65 | 19 |
| | Blackberry | 42 | 5 |
| | Rosemary (Control example) | 28 | 10 |
| | Green tea (Control example) | 25 | 10 |

### Example 4

Deodorization Rate for Methyl Mercaptan and Relative Enzyme Activity of Peroxidase at Each pH

A relationship between the deodorization rate for methyl mercaptan and a relative enzyme activity was examined at each pH in accordance with the test methods in Examples 1-2 and 2-1. Note that the enzyme activity of peroxidase under a condition at pH 4 to 8 was represented by the relative activity when the enzyme activity at pH 6.5 was defined as 100.

Note that, under the test condition of the deodorization rate for methyl mercaptan in the example, the amount of the Tien-cha extract contained in the reaction systems at pH 5 to 9 was 1.0 mg, the amount of the enzyme was 0 ng or 100 ng, and the reaction was performed at 37° C. for 5 minutes.

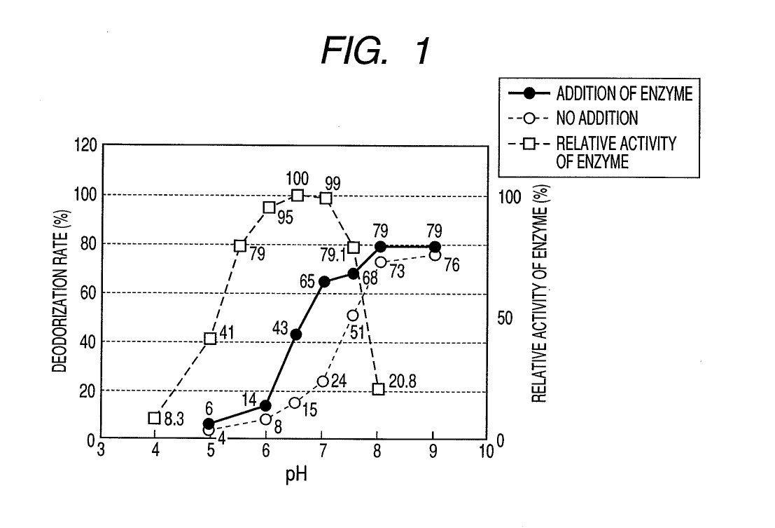

The deodorization rate when peroxidase was added (described as “addition of enzyme” in an explanatory note in FIG. 1) and the deodorization rate when peroxidase was not added (described as “no addition” in the explanatory note in FIG. 1) were plotted at pH 5, 6, 6.5, 7, 7.5, 8, and 9. Further, the enzyme activity of peroxidase alone (described as “relative activity of enzyme” in the explanatory note in FIG. 1) was plotted at pH 4 to 8.

As a result, the results as shown in FIG. 1 were obtained. As is evident from FIG. 1, it was observed that the deodorization rate was enhanced under the neutral condition at pH 6.0 to pH 8.0 by the addition of peroxidase. A pH value of whole saliva induced by stimulation has been reported to be about 6.8 to 7.5¹⁾. In the test, it was confirmed that the deodorization rate was remarkably enhanced at pH 6.5 to pH 7.5 which was in the range of the above-mentioned saliva pH by the addition of peroxidase.

1) Science of Saliva written by Jorma O. Tenovuo, p 44, published by Issei Shuppan Co., Ltd.

In particular, the remarkable increase of the deodorization rate for methyl mercaptan at pH 6.5 was also confirmed. This indicates a synergistic effect by the Tien-cha extract and peroxidase on the deodorization of methyl mercaptan.

### Example 5

Enzyme Concentration and Deodorization Rate for Methyl Mercaptan

The relationship between enzyme concentrations and the deodorization rates for methyl mercaptan was examined according to the test method in Example 2-1. Note that, in the example, the amount of the Tien-cha extract contained in the reaction system was 1.0 mg, the amount of the enzyme was 0 to 1,000 ng, and the reaction was performed at 37° C. at pH 7.0 for 5 minutes.

As a result, as is evident from the following Table 5, when the amount of the added Tien-cha extract was fixed to 1 mg, it was observed that the deodorizing activity for methyl mercaptan was enhanced as the added amount of peroxidase was increased from 10 to 100 ng. However, even when the added amount of peroxidase was increased to 100 ng or more, no remarkable enhancement of the deodorization rate for methyl mercaptan was observed.

TABLE 5

| | Titer of | Deodorization rate for |
|---|---|---|
| Peroxidase | peroxidase | methyl mercaptan (%) |
| (ng) | (U) | Tien-cha extract |
| 0 | 0 | 19 |
| 10 | 1.8 × 10⁻³ | 31 |
| 20 | 3.6 × 10⁻³ | 49 |
| 50 | 9.0 × 10⁻³ | 64 |
| 100 | 18.0 × 10⁻³ | 66 |
| 1,000 | 180 × 10⁻³ | 64 |

### Example 6

Substrate Concentration and Deodorization Rate for Methyl Mercaptan

The relationship between substrate concentrations of Tien-cha extract and the deodorization rates for methyl mercaptan was examined according to the test method in Example 2-1. Note that, in the example, the amount of the Tien-cha extract contained in the reaction system was 0.5 to 3.0 mg, the amount of the enzyme was 0 ng (described as “peroxidase (−)” in Table 6) or 100 ng (described as “peroxidase (+)” in Table 6), and the reaction was performed at 37° C. at pH 7.0 for 5 minutes.

As a result, as is evident from the following Table 6, when the amount of the added enzyme of peroxidase was fixed to 100 ng, it was observed that the deodorizing activity was enhanced as the added amount of Tien-cha extract was increased up to 2.0 mg. However, even when the added amount of Tien-cha extract was increased to 3.0 mg or more, no remarkable enhancement of the deodorization rate for methyl mercaptan was observed.

TABLE 6

| | |
|---|---|
| | Deodorization rate for |
| Added amount of Tien-cha | methyl mercaptan (%) |

| extract (mg) | Peroxidase (+) | Peroxidase (−) |
|---|---|---|
| 0.5 | 46 | 10 |
| 1.0 | 65 | 24 |
| 2.0 | 76 | 41 |
| 3.0 | 78 | 53 |

### Example 7

Test of Deodorization Effect by Produced Tablets

The deodorization rate for methyl mercaptan was evaluated according to the test method in Example 2-3 using the tablets prepared by the test method in Example 1-6.

As a result, as is evident from the following Table 7, it was found that the desirable amount of the extract from the plant belonging to the genus Rubus in the family Rosaceae (Tien-cha extract) used in the test to be blended in the composition was 0.01 to 5.0% by weight and preferably 0.05 to 2.0% by weight. When the amount of the extract from the plant belonging to the genus Rubus in the family Rosaceae to be blended in the composition is 0.05% by weight or less, a sufficient deodorization effect is not obtained. Even when the extract is blended in an amount of more than 2.0% by weight, the increase of the deodorization effect which is comparable to the increase of the added amount is not observed. It was also found that the amount of peroxidase used in the test to be blended in the composition was also dependent on the physical properties of the composition, and the desirable amount of peroxidase to be added was 0.01 to 10 ppm and preferably 0.01 to 2 ppm. When the above-mentioned amount of peroxidase to be added to the composition was represented by the titer, it was found that desirably, the titer of peroxidase was 0.18 U or more and 180 U or less and preferably 0.18 U or more and 36 U or less in terms of 100 g of the composition.

When the amount of peroxidase to be blended in the composition was 0.01 ppm (0.18 U/100 g of composition) or less, a sufficient deodorization effect was not obtained. Even when peroxidase was blended in an amount of more than 2 ppm (36 U/100 g of composition), the increase of the deodorization effect which was comparable to the increase of the added amount was not observed.

TABLE 7

| | Amount of | Titer of | Deodorization |
|---|---|---|---|
| Tien-cha | peroxidase | peroxidase | rate for |
| extract | preparation in | in 100 g of | methyl |
| (%) | tablet (ppm) | tablet (U) | mercaptan (%) |
| 0.10 | 0.00 | 0 | 10 |
| 0.01 | 0.10 | 1.8 | 4 |
| 0.05 | 0.10 | 1.8 | 18 |
| 0.10 | 0.01 | 0.18 | 12 |
| 0.10 | 0.05 | 0.9 | 23 |
| 0.10 | 0.10 | 1.8 | 26 |
| 0.20 | 0.20 | 3.6 | 45 |
| 0.40 | 0.40 | 7.2 | 65 |
| 0.80 | 0.80 | 14.4 | 78 |
| 1.20 | 1.20 | 21.6 | 83 |
| 1.60 | 1.60 | 28.8 | 85 |
| 2.00 | 2.00 | 36.0 | 86 |

### Example 8

Garlic Odor Suppression Effect by Produced Chewing Gum (Human Test)

A sensory evaluation method was performed according to the test method in Example 2-4, using the chewing gum prepared by the test method in Example 1-7.

As a result, as shown in the following Table 8, it was confirmed that the example chewing gum most strongly suppressed a garlic odor after being ingested.

TABLE 8

| | | Control example | Example |
|---|---|---|---|
| | Gargle | chewing gum | chewing gum |
| Before ingesting | 1.0 | 1.0 | 1.0 |
| steamed-baked | | | |
| meat pies | | | |
| After ingesting | 4.0 | 4.0 | 4.0 |
| steamed-baked | | | |
| meat pies | | | |
| After ingesting | 3.4 | 2.0 | 1.6 |
| chewing gum | | | |

### Example 9

A candy, a gummy jelly, and a troche were produced according to the following formulations using the extracts prepared by the methods shown in Examples 1-4 and 1-5.

FORMULATION OF CANDY

| Sugar | 50.0 wt % |
|---|---|
| Thick malt syrup | 34.0 |
| Citric acid | 2.0 |
| Blackberry extract | 0.2 |
| Peroxidase (180 U/mg) | 0.00001 |
| Flavor | 0.2 |
| Water | Balance |
| | 100.0 |

FORMULATION OF GUMMY JELLY

| Gelatin | 60.0 wt % |
|---|---|
| Thick malt syrup | 21.40 |
| Sugar | 8.5 |
| Plant fats and oils | 4.5 |
| Mannitol | 3.0 |
| Malic acid | 2.0 |
| Tien-cha extract | 0.1 |
| Peroxidase (180 U/mg) | 0.00002 |
| Flavor | 0.5 |
| | 100.0 |

FORMULATION OF TROCHE

| Glucose | 72.3 wt % |
|---|---|
| Lactose | 16.0 |
| Gum arabic | 6.0 |
| Flavor | 1.0 |
| Sodium monofluorophosphate | 0.7 |
| Tien-cha extract | 1.0 |
| Blackberry extract | 1.0 |
| Peroxidase (180 U/mg) | 0.00003 |
| Lactose | 2.0 |
| | 100.0 |

The present invention can be suitably utilized for the neutral food and drink articles including various confectionery such as chewing gums, candies, tablets, and gummy jellies.

This application claims the benefit of Japanese Patent Application Number 2008-207067 filed on Aug. 11, 2008, which is hereby incorporated by reference herein in its entirety.

1. A deodorizing composition comprising: a plant belonging to the genus Rubus in the family Rosaceae; and peroxidase.

2. A deodorizing composition according to claim 1, wherein the plant belonging to the genus Rubus in the family Rosaceae is one or two or more extracts selected from the group consisting of: a Tien-cha extract; a blackberry extract; and a raspberry extract.

3. A deodorizing composition according to claim 1, wherein a pH in saliva after ingesting the deodorizing composition is in a range of 6.0 or higher and 8.0 or lower.

4. A chewing gum, a candy, a tablet, or a gummy jelly, comprising the deodorizing composition according to claim 1.

5. A deodorizing composition according to claim 1, wherein a content of the plant belonging to the genus Rubus in the family Rosaceae in the deodorizing composition is 0.01% by weight or more and 5.0% by weight or less and a content of the peroxidase in the deodorizing composition is 0.01 ppm or more and 10 ppm or less.

6. A deodorizing composition according to claim 1, wherein a content of the plant belonging to the genus Rubus in the family Rosaceae in the deodorizing composition is 0.01% by weight or more and 5.0% by weight or less and a titer of the peroxidase added in the deodorizing composition is 0.18 U or more and 180 U or less in terms of 100 g of the deodorizing composition.

7. A deodorizing composition according to claim 2, wherein a pH in saliva after ingesting the deodorizing composition is in a range of 6.0 or higher and 8.0 or lower.

8. A chewing gum, a candy, a tablet, or a gummy jelly, comprising the deodorizing composition according to claim 2.

9. A chewing gum, a candy, a tablet, or a gummy jelly, comprising the deodorizing composition according to claim 3.

10. A chewing gum, a candy, a tablet, or a gummy jelly, comprising the deodorizing composition according to claim 7.

11. A deodorizing composition according to claim 2, wherein a content of the plant belonging to the genus Rubus in the family Rosaceae in the deodorizing composition is 0.01% by weight or more and 5.0% by weight or less and a content of the peroxidase in the deodorizing composition is 0.01 ppm or more and 10 ppm or less.

12. A deodorizing composition according to claim 3, wherein a content of the plant belonging to the genus Rubus in the family Rosaceae in the deodorizing composition is 0.01% by weight or more and 5.0% by weight or less and a content of the peroxidase in the deodorizing composition is 0.01 ppm or more and 10 ppm or less.

13. A deodorizing composition according to claim 7, wherein a content of the plant belonging to the genus Rubus in the family Rosaceae in the deodorizing composition is 0.01% by weight or more and 5.0% by weight or less and a content of the peroxidase in the deodorizing composition is 0.01 ppm or more and 10 ppm or less.

14. A chewing gum, a candy, a tablet, or a gummy jelly, comprising the deodorizing composition according to claim 5.

15. A chewing gum, a candy, a tablet, or a gummy jelly, comprising the deodorizing composition according to claim 12.

16. A chewing gum, a candy, a tablet, or a gummy jelly, comprising the deodorizing composition according to claim 12.

17. A chewing gum, a candy, a tablet, or a gummy jelly, comprising the deodorizing composition according to claim 13.

18. A deodorizing composition according to claim 2, wherein a content of the plant belonging to the genus Rubus in the family Rosaceae in the deodorizing composition is 0.01% by weight or more and 5.0% by weight or less and a titer of the peroxidase added in the deodorizing composition is 0.18 U or more and 180 U or less in terms of 100 g of the deodorizing composition.

19. A deodorizing composition according to claim 3, wherein a content of the plant belonging to the genus Rubus in the family Rosaceae in the deodorizing composition is 0.01% by weight or more and 5.0% by weight or less and a titer of the peroxidase added in the deodorizing composition is 0.18 U or more and 180 U or less in terms of 100 g of the deodorizing composition.

20. A deodorizing composition according to claim 7, wherein a content of the plant belonging to the genus Rubus in the family Rosaceae in the deodorizing composition is 0.01% by weight or more and 5.0% by weight or less and a titer of the peroxidase added in the deodorizing composition is 0.18 U or more and 180 U or less in terms of 100 g of the deodorizing composition.

21. A chewing gum, a candy, a tablet, or a gummy jelly, comprising the deodorizing composition according to claim 6.

22. A chewing gum, a candy, a tablet, or a gummy jelly, comprising the deodorizing composition according to claim 18.

23. A chewing gum, a candy, a tablet, or a gummy jelly, comprising the deodorizing composition according to claim 19.

24. A chewing gum, a candy, a tablet, or a gummy jelly, comprising the deodorizing composition according to claim 20.
